(19) United States
(12) Patent Application Publication
(10) Pub. No.: US 2015/0269652 A1
(43) Pub. Date: Sep. 24, 2015

(54) METHOD AND SYSTEM FOR PROCESSING PERIODIC ORDERS

(71) Applicant: Alibaba Group Holding Limited, Grand Cayman (KY)

(72) Inventors: Lujuan Xiao, Hangzhou (CN); Lixiang Huang, Hangzhou (CN); Xiachi Li, Hangzhou (CN)

(21) Appl. No.: 14/666,067

(22) Filed: Mar. 23, 2015

(30) Foreign Application Priority Data
Mar. 24, 2014 (CN) 201410111493.6

(51) Int. Cl. G06Q 30/06; G06F 17/30; G06Q 10/06; H04L 29/08

(52) U.S. Cl. CPC G06Q 30/0633; H04L 67/02; G06F 17/30312; G06Q 10/063116

(57) ABSTRACT

A method and a system for processing periodic orders placed by e-commerce user. A server system is used to determine execution times of multiple tasks of placing orders according to a user request received for placing periodic orders of a selected product. The server system generates and stores into a database the periodic tasks. Application servers read from the database, due tasks and execute the read due tasks to create logistic orders for shipping the product. The user periodically receives ordered product at specified times, without a need to re-order.

### RELATED PATENT APPLICATIONS

This application claims foreign priority to Chinese Patent Application No. 201410111493.6 filed on Mar. 24, 2014, entitled “METHOD AND SYSTEM FOR PROCESSING PERIODIC ORDERS”, which is hereby incorporated by reference in its entirety.

### TECHNICAL FIELD

This application relates to e-commerce platform technology, and more particularly, to methods and systems for processing customer orders.

### BACKGROUND

With the improvement of e-commerce platforms, as well as the rapid development of conventional communications and mobile communications, more and more people are shopping online. The type of goods that are available for online shopping cover every aspect of people's daily lives, offering a lot of convenience.

During online shopping, people may have a need to make periodic purchases. For example, certain consumption items, such as milk, rice and so on, may need to be purchased regularly every month or every week. However, people often forget to buy these things, or feel that making weekly or monthly purchase is a lot of trouble. Therefore, there is a need for technical solutions to meet such online shopping needs.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

One aspect of the disclosure is a method for processing periodic orders placed by an e-commerce user. A server system is used to determine execution times of multiple tasks of placing orders according to a user request received for placing periodic orders of a selected product. The server system generates and stores into a database the periodic tasks. Application servers read from the database, at preset task reading periods, due tasks having execution times falling in a current reading period, and execute the read due tasks to create logistic orders for shipping the product. As a result, the user periodically receives ordered product at specified times, without a need to re-order.

Distributing the due tasks may be done by a control server in the server system in concert with the application servers. For example, each application server may receive instructions from the control server to use an algorithm designed to distribute the due tasks in the current receiving period among the plurality of application servers. Using the instructions and the algorithm, each application server determines which of the due tasks are to be read by the application server.

Distributing the due tasks among a plurality of application servers may be done by assigning an ID number to each of the application servers and an ID number to each due task; computing, for each due task, a modulus of the total number of the application servers over the respective ID number of the due task; and distributing, to each application server, the due tasks whose modulus matches the ID number of the respective application server.

The method also monitors server downtimes and redistributes the due tasks among the remaining application servers.

In addition, the method also avoids tasks duplication and task omission. For example, the preset task reading periods may have multiple reading threads each including a nonidentical set of task reading periods. Each set of task reading periods of each reading thread has evenly divided time intervals, and the interval length increases from one thread to a next thread in order to great a graduated, partially overlapping brackets to sweep up previously missed tasks.

Another aspect of the disclosure is a computer system for processing periodic orders. The computer system has a control server and a plurality of application servers, each server having a processor, computer-readable memory and storage medium, and I/O devices. The computing system is programmed to have functional units such as below.

An order preparation unit determines respective execution times of a plurality of tasks of placing orders according to a user request received for placing periodic orders of a selected product.

A task creation unit generates and stores into a database the plurality of tasks including such data as the respective due execution times and product information carried in the user request.

A task distribution unit distributes, using the control server, the due tasks in the current receiving period among the plurality of application servers.

A task execution unit executes, at preset task reading periods, due tasks having execution times falling in a current reading period to create logistic orders for shipping the product.

Other features of the present disclosure and advantages will be set forth in the following description, and in part will become apparent from the description, or understood by practice of the application. Purposes of this application and other advantages can be obtained by the written description, claims, and drawings of the structure particularly pointed out realized and attained.

### BRIEF DESCRIPTION OF THE FIGURES

FIG. 1 is a block flow diagram of an example process for processing periodic orders.

FIG. 2 is a schematic diagram of the function blocks of an example system for processing periodic orders.

### DETAILED DESCRIPTION

The present disclosure is described in further detail in conjunction with accompanying figures and example embodiments. In the description, the term “technique(s),” for instance, may refer to a method, an apparatus device, a system, and/or computer-readable instructions as permitted by the context above and throughout the present disclosure.

In this description, the order in which a process is described is not intended to be construed as a limitation, and any number of the described process blocks may be combined in any order to implement the method, or an alternate method. An embodiment is described in sequential steps only for the convenience of illustration. Unless it would cause a conflict, the examples and embodiments described in the present disclosure, and the characteristics and features thereof, may be combined freely. Further, not every step described in the embodiments is required in order to practice the techniques of this disclosure.

Embodiments in the present disclosure provide on top of an existing e-commerce platform means for users to make periodic purchases of a certain product. Using the disclosed features, users can pay for a certain period of time (e.g., a year, or any other longer or shorter period of time) to purchase a selected product. During the paid period of time, periodic orders of the selected product may be automatically shipped and repeated at shorter periods such as every month or every week. In order to do this, technically the e-commerce platform needs to manage the logistics process in order to make periodic shipments at the right time, not earlier nor later. Both the stocking and shipping need to be timed accurately. Upon receiving from the e-commerce platform a request for periodic orders, N logistic orders may be created, with each logistic order having a specific time to take place, so that stocking and shipping may be prepared timely according to the logistic orders.

In order that the periodic orders are executed timely, a task scheduling system is used to read periodically (e.g., every five minutes, 30 minutes, one hour, or one day etc.) from a database those tasks that are due for execution. The read tasks are executed to generate periodic orders, which are sent to a logistic system for preparing stocking and shipping. The process is described in detail below.

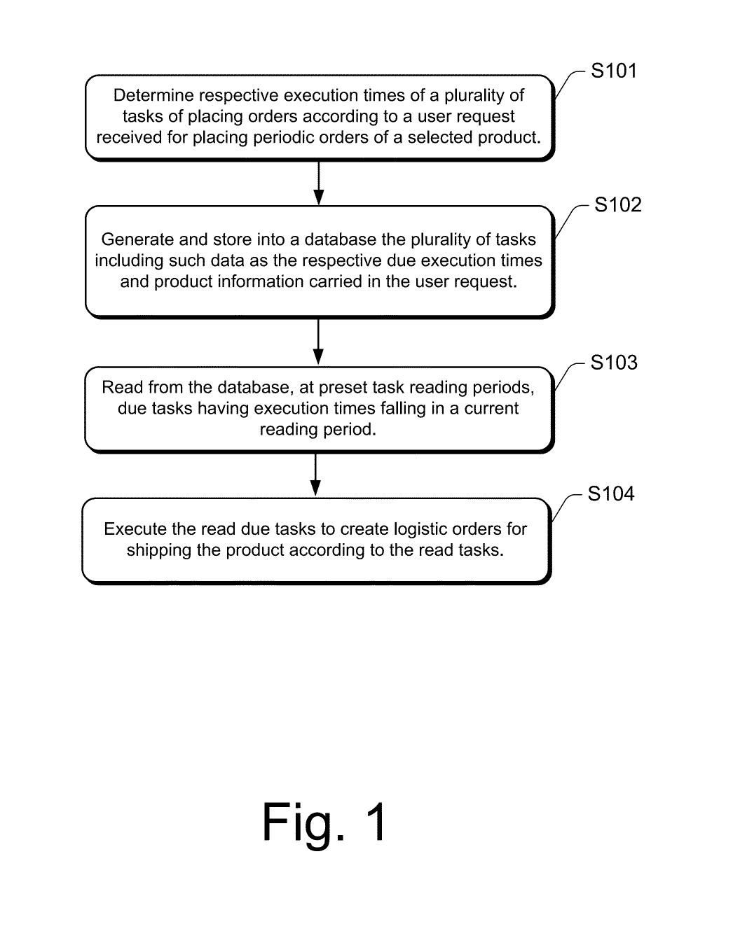

FIG. 1 is a block flow diagram of an example process for processing periodic orders.

At Block S101, a system determines execution times of a series of tasks for placing orders according to a user request for placing periodic orders of a selected product.

In practice, a user interface is provided for the user to submit a request for placing periodic orders. The user uses the user interface to select the product to be ordered, and specifies the total number of periodic orders (e.g., six orders or 12 orders, each order corresponding to sequential period), the length of each repeatable period (e.g., one order per week, or per month), and the quantity of the product to be shipped per order. The user may also choose specific shipping times, such as the first day of each month. Upon submitting the request, the user subsequently receives the periodic orders of the selected product without manually placing these periodic orders.

Upon receiving the request submitted by the user, the system determines the stocking time for each periodic order according to the shipping information carried in the request. If the shipping information specifies shipping times of the requested periodic orders, the system may determine the stocking time according to the specified shipping times. For example, if the specified shipping time is the 25^{th} date of every month, the stocking time may be determined to be the 24^{th} date of every month, providing one day of inventory preparation. The system may treat the stocking time as the execution time of the task for placing a periodic order.

At block S102, the system generates and stores into a database the tasks including such data as the respective execution times and product information carried in the user request.

Upon determining the execution times of the tasks for placing the periodic orders, the system may generate the corresponding tasks, and store the tasks in the database. For example, if the user requests 12 periodic orders of the product, the system will generate 12 tasks for placing the 12 periodic orders requested, and store the tasks into the database. Each task has its execution time and the ordered product information, such as the product ID, model, and quality, etc. The tasks may also include user information to specify the recipient of the order. In this manner, the request for periodic orders is divided to multiple tasks to be executed. In an embodiment, the tasks are stored in the database as tables, as shown in Table 1:

TABLE 1

| | | | | | Execution |
|---|---|---|---|---|---|
| Task ID | Product ID | User ID | Model | Quantity | time |
| 1 | 10001 | U1 | X1 | N1 | Time 1 |
| 2 | 10001 | U2 | X1 | N1 | Time 2 |
| . . . | | | | | |

It should be noted that the e-commerce platform may have a large number of users placing periodic orders, and as a result may generate a large amount of data for tasks. For the convenience of backend reading of the data, the tasks may be stored in multiple tables. For example, the tasks may be divided into multiple tables according to the execution times of the tasks. All tasks that have an execution time on the same day may be placed within the same table, and stored accordingly. The tables may be divided with even finer granularity. For example, tasks for each day may be divided to 24 tables, with each table containing the data for tasks within an hour. This reduces the size of the tables stored in a database, and may improve the efficiency of backend reading. With this practice, the tasks generated for the periodic orders requested by the same user may be placed into different tables.

At block S103, the system reads from the database, at preset task reading periods, tasks having execution times falling in a current reading period.

In one embodiment, the system has multiple application servers which read the tasks from the database. The application servers are preconfigured to read tasks that have execution times due in the current reading period. For example, the application servers may read tasks every five minutes, and each time may read all tasks that have an execution time within the current five minute period.

At block S104, the system executes the tasks read at block S103 to create logistic orders for shipping the product according to the respective tasks.

Once the tasks are read, logistic orders are created based on the product information and the user information contained in the tasks. Notifications of the logistic orders may be sent to the warehouse system so that the warehouse may prepare the stocking for shipping.

The procedure ensures that all tasks in the database are executed at the scheduled times, and the user may receive the ordered product at requested times without having to placing orders monthly or weekly.

To send notifications to the warehouse system, a call interface of the warehouse is obtained in advance, so that once the logistic order is created, the warehouse system interface may be called, and the order information such as the product ID, the product specification, and the product quality in the order may be sent to the warehouse system for stocking and inventory preparation. In addition, the shipping information such as the address of the recipient of the ordered product may also be determined and sent to the warehouse system to prepare for proper shipping after stocking.

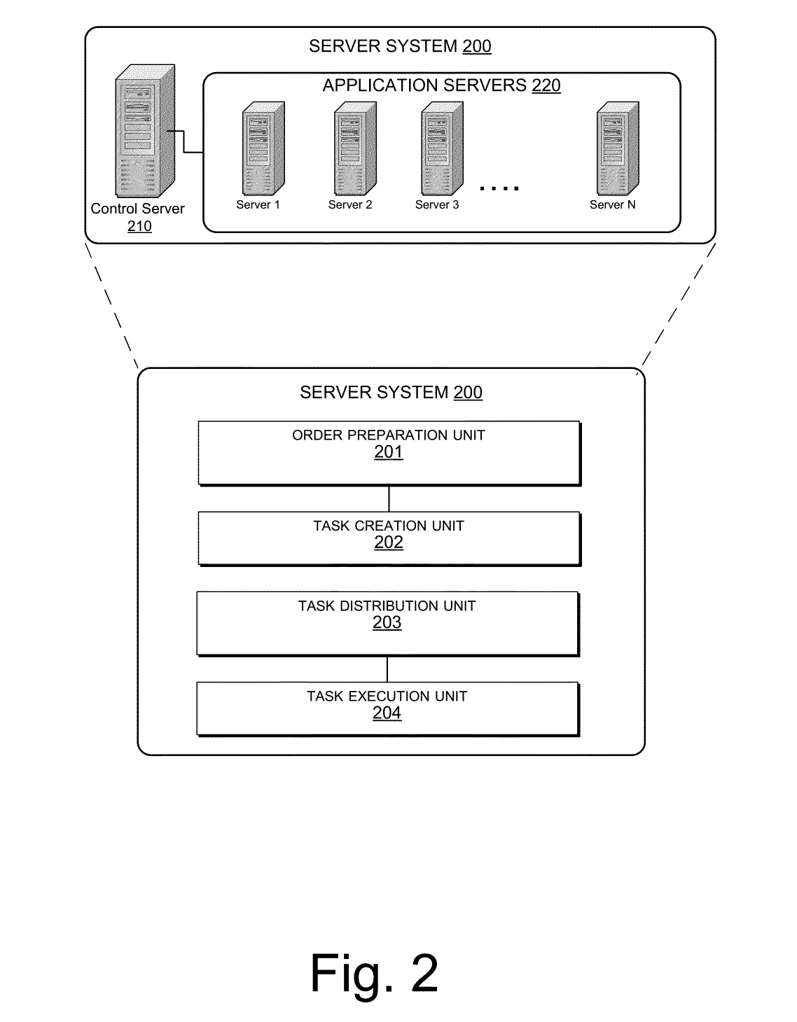

If the number of the tasks is not too large, a single application server may be sufficient. However, if the number of the tasks is large, a cluster of application servers (e.g., application servers 220 in FIG. 2) may be used to carry out these timed periodic tasks. In this scenario, the system may include a control server (e.g., control server 210 in FIG. 2) to send controlled instructions to the application servers.

To distribute the tasks among the application servers, the system needs to determine the identities of the due tasks that may be received by each application server. In one embodiment, each application server uses a preconfigured algorithm to determine the identities of the due tasks that may be received by the respective application server. The algorithm is preferably optimized for evenly distributing the tasks in the current reading period among the available application servers. The application servers may use a shared clock to time the task reading periods.

For example, in practice, a hash algorithm may be used for evenly distributing the tasks. The control server assigns a server ID to each the application server Available in the system, and when sending the control instructions to an application server, the control server includes in the control instructions such information as the total number of the application servers available in the system and the server ID of the application server receiving the control instructions. For instance, if the total number of application servers is 10, and the application server A is assigned a server ID 0, the control instructions sent by the control server to the application server A would contain such data to indicate that the total number of servers is 10, and the assigned ID number for the application server A is 0.

To receive the right tasks from the database, the application server may make determinations in two aspects. First, the execution time of each task to be received should fall within the current reading period. Second, the ID number of each task to be received should satisfy the rules defined by the algorithm.

In one embodiment, the system assigns an ID number to each the application server And assigns an ID number to each due task. The system computes, for each task, a modulus of the total number of the application servers over the respective ID number of the task. Specifically, the system computes the remainder of the total number of application servers divided by the ID number of the task in question. Because the total number of application servers is a constant system wide, the modulus thus computed represents a characteristic mark of the task whose ID number is used for computing the modulus. The system then distributes, to each application server, the tasks whose modulus matches the ID number of the respective application server. The modulus computation may be done by the application servers. For example, each application server computes the modulus of the total number of application servers over the ID number of each task, and selects and reads those tasks resulting in a modulus that matches the ID number of the said application server.

For example, assuming the reading period is five minutes, when the application server A reads at the time of 11:55 the tasks due at the current reading period, the application server A first determines if a task has an execution time that falls between 11:50 and 11:55, and if yes, further determines if the modulus of the total number of application servers computed over the ID number of the task matches the ID number of the application server A. If affirmative, the application server A reads the task; but if native, the application server A does not read the task. Using this technique, the tasks within the same reading period are evenly distributed to the available application servers to be executed, avoiding a situation where some servers are overloaded while others are under loaded. For example, when there are 10 application servers with ID numbers 0, 1, 2, 3, 4, 5, 6, 7, 8, and 9, respectively, the application server with the ID number 0 requires the following conditions to be met in order to read a task: the modulus of 10 over the ID number of the task is 0 (that is, to match the application server's ID number which is 0). Likewise, the application server with the ID number 1 requires the following condition to be met in order to read a task: the modulus of 10 over the ID number of the task is 1 (that is, to match the application server's ID number, which is 1), and so on. All tasks are evenly distributed among the application servers this way.

The modulus computation may alternatively be done by the control server which then pushes the right task to the right application server.

In practice, application servers may experience downtime, or some tasks may be successfully read but may have not been successfully executed due to various reasons. This would result in certain tasks not being executed. This disclosure provides techniques to solve such problems.

In an embodiment, the preset task reading periods have multiple reading threads each including a nonidentical set of task reading periods. The set of task reading periods of each reading thread may have evenly divided time intervals. Different task reading threads may have different lengths of the intervals which, for example, intervals may increase from one thread to a next thread.

For example, one reading thread may have a reading period of five minutes, another a reading period of 20 minutes, another a reading period of one hour, another one day, and yet another two days, etc. Generally, each application server should have a limited number of threads. Usually, the maximum length of the reading period may not need to be longer than two days to ensure that all tasks are picked up after all reading threads have been applied.

Each reading thread reads tasks from the database according to its own periodic schedule. For example, a thread that has a five minute reading period reads tasks in the database once every five minutes, while a thread that has a 20 minute reading period reads tasks in the database once every 20 minutes. Because the identities of the tasks to be read by all threads of the same the application server are determined by the total number of the application servers and the ID number of the same application server, all threads of the same application server uses the same rule to select tasks in the database. This would result in a task being read multiple times by different reading threads of the same application server.

For example, the application server A's ID number is 0, and it has a reading thread 1 with a reading period of five minutes, reads 10 tasks among the tasks due between 11:50 and 11:55, where the ID numbers of the 10 read tasks all should result in a modulus 0 for number 10, which is the total number of the application servers (that is, 10 divided by the ID number of any of the 10 read tasks should have a remainder of 0 to match the ID number 0 of the application server A). The application server A also has a reading thread 2 with a reading period of 20 minutes, reads tasks among the tasks due between 11:40 and 12:00, where the ID numbers of these read tasks should also result in a modulus 0 for number 10. As a result, the reading thread 2 would read some of the tasks that are also read by the reading thread 1, and this may cause a problem.

In order to avoid the same task from being repeatedly executed, the tasks that have already been executed are marked as being completed to allow a future reading thread to avoid reading the executed due tasks again. With this design, a subsequent reading thread of the same application server would only read those tasks that have not been marked as being completed, thus avoiding the same task from being read again by the subsequent reading thread.

Another possible scenario is where a certain task may be read by subsequent reading thread 2 after the task has been read by the reading thread 1 but has not been executed yet. This may cause a problem because if the task is eventually executed by thread 1, it might be executed again by the thread 2 which reads the same task before the task is executed by the thread 1 and was thus not marked as done at the time. In this scenario, in order to avoid the task from being executed more than one time, all tasks read by the reading threads of the same application server may be first written into a combined task execution queue, and all duplication of the tasks may be removed and not included in the combined task execution queue. The reading threads then reads tasks to be executed from the combined task execution queue.

Another possible scenario is that a task may be read but never executed after all reading threads have read and executed the tasks. For example, suppose a task has an execution time of 11:52 on February 17. The task was first read at 11:55 on February 17 by a thread having a reading period of five minutes, but was not successfully executed, and therefore not marked as done. The same task was then read again at 12:00 by a thread having a reading period of 20 minutes, but was again not successfully executed. Subsequently, the same thread may be read a third time at 0:00 on February 18 by a thread having a reading period of one day. If still not executed, the task may be read a fourth time at 0:00 on February 19 by a thread having a reading period of two days. At this point, the task may not be read again as all reading threads have been executed and there is no more reading thread left. If still not executed, the task is written into an exception queue to be executed from the exception queue.

If the task remains unexecuted even after the execution of the exception queue, it may be a failure caused by other system problems, so a notification should be sent to the administrative personnel to allow the task to be handled using administrative means. In addition, a maximum number may be set for the total number of tasks that can be included in the exception queue, so that if the exception queue exceeds the maximum number, the administrative personnel may be alerted.

Using multiple reading threads for the same application server, the tasks are assured to be read and executed even if an application server is down. To do this, the system can monitor the application servers, and distribute the tasks in the current receiving period among the application servers that are still available and not experiencing a downtime. In one embodiment, when a downtime of one or more application servers is detected, the system assigns different ID numbers to the remaining application servers, and re-sends instructions for reading the due tasks to the remaining application servers. This allows the tasks to be redistributed among the remaining application servers. For example, if the application server with ID number 7 is down, after reassigning the ID numbers to the remaining servers, the application servers originally with ID numbers 8 and 9 are assigned new ID numbers 7 and 8, while the total number of remaining application servers becomes 9. Upon receiving the new instructions, the remaining application servers still have the same reading threads and the same clock, but will now find different tasks to read because of the change of the ID numbers of the servers, which would lead to different modulus matching results.

For example, at 11:55, the thread 1 of the application server A reads 10 tasks among the tasks having execution times between 11:50 to 11:55. The application server A goes down at 11:57, with some of the tasks executed, but some unexecuted. While the other application servers remain available, the control server reassigns ID numbers to the remaining application servers, and resends the control instructions. For instance, the application server B has a thread 1 with the reading period of five minutes, most recent reading occurring at 11:55. After receiving the resent control instructions, the application server B will perform the next reading at 12:00 to read tasks having execution times between 11:55 to 12:00. The tasks that have been read by the application server A but still unexecuted may be read again by a thread that has a reading period of 20 minutes or longer. For example, another thread that has a reading period of 20 minutes had its most recent reading at 11:40, and upon receiving the new control instructions, will perform the next reading at 12:00 to read tasks that have an execution time between 11:40 and 12:00 and have not been marked as done. These tasks may include the tasks that are due between 11:50 to 11:55 and were previously read by the application server A, but still remain unexecuted. Because the total number of the available application servers has changed, the tasks in the database would be redistributed among the remaining application servers and read by a different application server. As long as the new server that picks up the unexecuted tasks is not down, these tasks will be executed.

In summary, the techniques disclosed herein ensure that when there are many tasks, the tasks that are due are neither left out unexecuted nor executed multiple times. The techniques are also suitable for scaling of the system. When there is a sudden increase in the number of tasks, more application servers may be added to ensure a balanced task load among the servers. When new application servers are added, the control server may also reassign server ID numbers to the available application servers, and resend the control instructions to the available application servers in order to ensure that the tasks are evenly distributed among the available application servers. In addition to adding new application servers, the system's task reading capacity may also be increased by adding new reading threads to the existing application servers. In this scenario, the control server does not need to resend the control instructions. The system only needs to set up the reading periods of the new reading threads and initiate the new reading threads.

In connection to the method disclosed herein, the present disclosure also provides a server system for implementing the method described herein.

The above-described techniques may be implemented with the help of one or more non-transitory computer-readable media containing computer-executable instructions. The non-transitory computer-executable instructions enable a computer processor to perform actions in accordance with the techniques described herein. It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

In the presence disclosure, a “unit” or a “module” in general refers to a functionality designed to perform a particular task or function. A module or a unit can be a piece of hardware, software, a plan or scheme, or a combination thereof, for effectuating a purpose associated with the particular task or function. In addition, delineation of separate modules or units does not necessarily suggest that physically separate devices are used. Instead, the delineation may be only functional, and the functions of several modules or units may be performed by a single combined device or component. When used in a computer-based system, regular computer components such as a processor, a storage and memory may be programmed to function as one or more modules or units to perform the various respective functions.

FIG. 2 is a schematic diagram of the function blocks of an example server system for processing periodic orders. The server system 200 include control server 210 and application servers 220. Servers may each have one or more processor(s), I/O devices, computer-readable memory and storage medium which stores application program(s). The server system 200 is programmed to have the following functional units.

An order preparation unit 201 is programmed for determining respective execution times of a plurality of tasks of placing orders according to a user request received for placing periodic orders of a selected product.

A task creation unit 202 is programmed for generating and storing into a database the plurality of tasks including such data as the respective execution times and the product information carried in the user request.

A task distribution unit 203 is programmed for distributing the tasks due in the current receiving period among the plurality of application servers.

A task execution unit 204 is programmed for executing, at preset task reading periods, tasks having execution times falling in a current reading period, to create logistic orders for shipping the product.

In practice, multiple application servers 220 are used in a distributed configuration to handle large numbers of tasks. In one embodiment, the task distribution unit 203 includes subunits that are each implemented on an application server, which uses the control instructions received from the control server 210 and a preconfigured algorithm to determine the identities of the tasks that may be read the respective application server. The algorithm is designed to evenly distribute the tasks that are due in the current reading period among the available application servers 220.

To ensure that tasks are executed even when some of the application servers 220 are down, the control server 210 monitors the running condition of the application servers 220, and resends the control instructions to the available application servers 220 if one or more of the application servers 220 are down.

In practice, the control server 210 assigns server ID numbers to the available application servers 220, and includes the server ID number in the instructions sent to the respective application server 220. Each application server 220 is programmed to have the following modules (not shown) in order to determine the identities of the tasks that may be read by the respective application server 220.

A modulus computation unit is programmed for computing the modulus of the total number of available application servers over the ID number of each task that is due.

An identity determination unit is programmed for determining the identities of the tasks that may be read by the application server by matching the modulus computed using the ID number of each task with the ID number of the application server.

As described herein with FIG. 1, each application server may have multiple reading threads each reading from the database the tasks due in the current reading period defined by the reading thread. Different reading threads have different reading periods that are overlapping to ensure tasks have multiple chances to be picked up.

The task distribution unit 203 may be further programmed for assigning an ID number to each the application server and assigning an ID number to each due task; computing, for each due task, a modulus of the total number of the application servers over the respective ID number of the due task; and distributing, to each application server, the tasks whose modulus matches the ID number of the respective application server.

The system may include other functional units such as a task marking unit for marking a task as done after the task has been executed.

Each application server 220 may have at least one reading thread, and the same application server further has an execution queue writing unit programmed for writing all tasks read by different reading threads a combined execution queue.

To avoid a task from being executed more than once, the system may also include units programmed for performing other acts as described with FIG. 1, such as removing duplication of the tasks in the same execution queue, writing a task into an exception queue if the task is not executed after all reading threads have been executed, and sending logistic orders to the warehouse system by calling a known interface to the warehouse system.

Using the above-described method and system, tasks corresponding to the periodic orders requested by the user are created, stored, read, and managed using a distributed application server system running multiple task reading threads to ensure timely and reliable execution of the tasks. When executed, these tasks ensure that the product is shipped automatically at the right times with right quantities as requested by the user without requiring the user to place such periodical orders manually.

In a typical configuration, computer memory may include a computer-readable medium such as a volatile memory, random access memory (RAM) and/or other forms of nonvolatile memory, such as read only memory (ROM) or flash memory (flash RAM). The internal memory of a computing device is a type of computer-readable memory medium.

The computer-readable media include permanent and non-permanent, removable and non-removable media, and may be formed in any method or technology for storage of information. Information stored may be a set of computer-readable instructions, data structures, program modules or other data. Examples of the computer storage media include, but are not limited to, phase-change memory (PRAM), a static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storages, magnetic cassettes, magnetic tape disk storage or other magnetic storage devices, or any other non-transmission medium that may be used to store information accessible by a computing device. According to the definitions of the present disclosure, computer-readable media do not include temporary computer readable media (transitory media), such as a modulated data signal and a carrier wave.

The modules or units in particular may be implemented using computer programs based on machine executable commands and codes. Generally, a computer program may perform particular tasks or implement particular abstract data types of routines, programs, objects, components, data structures, and so on. Techniques described in the present disclosure can also be practiced in distributed computing environments, such a distributed computing environment, to perform the tasks by remote processing devices connected through a communication network. In a distributed computing environment, programmed modules or units may be located in either local or remote computer storage media including memory devices.

Various embodiments of the present specification are described progressively increased details with examples and environments. Each embodiment may focus a certain aspect of the disclosure, and therefore different embodiments may differ from one another, but may also share similar parts.

Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields.

What is claimed is:

1. A method for processing periodic orders, the method comprising:
determining respective execution times of a plurality of tasks of placing periodic orders according to a user request received for placing the periodic orders of a selected product;
generating and storing into a database the plurality of tasks including such data as the respective due execution times and the selected product's information;
reading due tasks from the plurality of tasks stored in the database; and
executing the read due tasks to create logistic orders for shipping the product according to the read tasks.

2. The method as recited in claim 1, further comprising:
distributing the due tasks in the current receiving period among a plurality of application servers.

3. The method as recited in claim 2, wherein distributing the due tasks is carried out by a control server using a predesigned algorithm.

4. The method as recited in claim 2, wherein distributing the due tasks comprises:
receiving, by each application server, instructions from a control server to use an algorithm designed to distribute the due tasks in the current receiving period among the plurality of application servers; and
determining, by each application server, using the instructions and the algorithm, which once of the due tasks are to be read by the respective application server.

5. The method as recited in claim 2, wherein distributing the due tasks comprises:
monitoring the plurality of application servers; and
distributing the due tasks in the current receiving period among the application servers not experiencing a downtime.

6. The method as recited in claim 2, wherein distributing the due tasks comprises:
monitoring the plurality of application servers; and
sending instructions for reading the due tasks to the application servers not experiencing a downtime.

7. The method as recited in claim 2, further comprising:
monitoring the plurality of application servers; and
when a downtime of one or more application servers is detected, redistributing the due tasks in the current receiving period among the application servers not experiencing a downtime.

8. The method as recited in claim 2, wherein distributing the due tasks among the plurality of application servers comprises:
assigning an ID number to each application server, and assigning an ID number to each due task;
computing, for each due task, a modulus of the total number of the application servers over the ID number of the respective due task, and
distributing, to each application server, the due tasks which have resulted in a modulus matching the ID number of the respective application server.

9. The method as recited in claim 8, wherein assigning an ID number to each application server is carried out by a control server.

10. The method as recited in claim 2, wherein distributing the due tasks in the current receiving period among the plurality of application servers comprises:
sending an instruction to each application server, the instruction including data indicating a total number of the application servers and the respective ID number of the application server receiving the instruction;
determining, at each application server, which ones of the due tasks correspond to a modulus matching the ID number of the respective application server, the modulus corresponding to each due task being the remainder of the total number of the application servers divided by the respective ID number of the due task; and
reading, by each application server, only the due tasks that correspond to a modulus matching the ID number of the respective application server.

11. The method as recited in claim 10, wherein sending an instruction to each application server is carried out by a control server.

12. The method as recited in claim 1, further comprising:
marking the due tasks that have been executed as completed to allow a future reading act to avoid reading the executed due tasks again.

13. The method as recited in claim 1, wherein the preset task reading periods include a plurality of reading threads each having a nonidentical set of task reading periods.

14. The method as recited in claim 13, wherein the set of task reading periods of each reading thread has evenly divided time intervals, each interval's length increasing from one thread to a next thread.

15. The method as recited in claim 13, further comprising:
writing into an exception queue due tasks that remain unexecuted after all of the plurality of reading threads have been executed.

16. The method as recited in claim 1, wherein reading the due tasks from the database is distributed among a plurality of application servers, the preset task reading periods of each application server comprising a plurality of reading threads each including a nonidentical set of task reading periods, the method further comprising:
for each application server, writing into a combined task execution queue the due tasks read by the application server using the plurality of reading threads, and eliminating duplication of the due tasks in the combined task execution queue.

17. A method for processing periodic orders, the method comprising:
determining respective execution times of a plurality of tasks of placing periodic orders according to a user request received for placing the periodic orders of a selected product;
generating and storing into a database the plurality of tasks including such data as the respective due execution times and the selected product's information;
distributing the plurality of tasks among a plurality of application servers; and
executing, due tasks to create logistic orders for shipping the product.

18. The method as recited in claim 17, wherein distributing the plurality of tasks among the plurality of application servers comprises:
assigning an ID number to each the application server, and assigning an ID number to each task;
computing, for each task, a modulus of the total number of the application servers over the respective ID number of the due task, and
distributing, to each application server, the tasks having ID number resulting in the modulus matching the ID number of the respective application server.

19. A computer system for processing periodic orders, the computer system comprising a control server and a plurality of application servers, each server having a processor, computer-readable memory and storage medium, and I/O devices, wherein the computing system is programmed to have functional units including:
an order preparation unit for determining respective execution times of a plurality of tasks of placing periodic orders according to a user request received for placing the periodic orders of a selected product;
a task creation unit for generating and storing into a database the plurality of tasks including such data as the respective due execution times and the selected product's information;
a task distribution unit for distributing the tasks due in the current receiving period among the plurality of application servers; and
a task execution unit for executing due tasks to create logistic orders for shipping the product.

20. The method as recited in claim 19, wherein the task distribution unit is further programmed for:
assigning an ID number to each the application server, and assigning an ID number to each task;
computing, for each task, a modulus of the total number of the application servers over the respective ID number of the due task, and
distributing, to each application server, the tasks having ID number resulting in the modulus matching the ID number of the respective application server.
